(19) United States
(12) Patent Application Publication
(10) Pub. No.: US 2008/0026106 A1
(43) Pub. Date: Jan. 31, 2008

(54) Fruit based food product and related method

(76) Inventors: Sanford B. Weiss, Los Angeles, CA (US); Andrew I. Wolf, Los Angeles, CA (US)

Correspondence Address: STETINA BRUNDA GARRED & BRUCKER, 75 ENTERPRISE, SUITE 250, ALISO VIEJO, CA, 92656, US

(21) Appl. No.: 11/495,861

(22) Filed: Jul. 28, 2006

(51) Int. Cl. A23L 1/30

(52) U.S. Cl. 426/72

(57) ABSTRACT

A balanced food product and related method for preparation of the same is provided for optimizing the metabolism of the body of the consumer. The balanced food product may include a first fruit component, a second fruit component, and a protein component, as well as a sweetener component, and an oil binding agent component. Each of the components contributes an amount of carbohydrates, protein, and fat so as to yield a particular predetermined ratio therebetween and selectively provide a predetermined glycemic load to the consumer.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to food products. More particularly, the present invention relates to snack food products having balanced nutritional properties and related methods of making the same.

2. Related Art

Snack foods are typically a staple of any diet. Indeed, a substantial section of the public has displayed a penchant for “grazing” on small amounts of food throughout the day, sometimes in lieu of eating regular meals, and for those with higher appetites, in addition to eating such regular meals. Not surprisingly, these trends have fostered a substantial demand for a increased variety of snacks, including high-fat/high-calorie potato chips, candy bars, and the like, as well as fruit based snacks, that to a certain extent have better nutritional value. Particularly desirable are snack foods that can be made from all natural ingredients, preferably made entirely from fruit.

According to other advancements in nutritional science, it has been suggested that when particular levels of certain hormones, namely, insulin and eicosanoids, are neither too high nor too low, the human body halts the storage of excess calories as fat. Considering that the human body cannot store and burn fat concurrently, and that switching between storage and burning takes time, it has been theorized that by continuously balancing the level of hormones such that stored fat is steadily burned for the energy needs of the body, weight loss may result. Other beneficial results have been identified, and in particular decreased chronic inflammation, which has been suggested as being the primary cause of cardiovascular disease, as well as adversely affecting mental and physical capabilities. Essentially, it has been suggested that by controlling the metabolism rate, the body can be brought back to a state of equilibrium in all respects.

Further, research has shown that a particular percentage of carbohydrates, proteins, and fats for a given intake of food are effective to properly regulate the insulin and eicosanoid levels within the body. While the specific effective percentages may vary, generally it is understood to be 40% carbohydrates, 30% proteins, and 30% fats. Carbohydrates as generally understood in the nutritional context, essentially provide energy to the cells of the body. Common classifications include simple carbohydrates (monosaccharides and disaccharides) and complex carbohydrates (oligosaccharides and polysaccharides), depending on the chemical structure and chain length. It is well known that as the body digests carbohydrates, the carbohydrate compound is broken down into individual monosaccharide units, resulting in glucose being released into the bloodstream. Thus, the more complex the carbohydrate structure, the greater amount of time it takes to release the energy stored therein. In this regard, a ranking system known in the art as a glycemic index has been developed to determine the effects of a given carbohydrate on blood glucose levels. The glycemic index of a food item, coupled with the amount of the food item consumed can be calculated to derive the glycemic load, which is indicative of the actual blood glucose and insulin response effect.

As is also well understood, proteins are essential to the structure and function of all cells in the body, including metabolism. During digestion, proteins are broken down into polypeptides to ultimately provide amino acids. Amino acids essential to metabolism include isoleucine, leucine, lysine, methionine, phenylalanine, threonine, tryptophan, and valine. With regard to the fat component, it has been suggested that monounsaturated fats in a meal contribute to a feeling of fullness and operate to modulate the rate of carbohydrate absorption. By limiting the absorption of carbohydrates, it is believed to enable the body to transition from storing fat to burning fat.

Given the high demand for snack foods consumed between major meals, there is a need in the art for a balanced food product having the desirable attributes of promoting hormonal and metabolic balance in the body of the consumer, especially in relation to the metabolism of carbohydrates, while limiting the total caloric quantity so as to retain nutritional characteristics which are consistent with a snack.

### BRIEF SUMMARY

The present invention specifically addresses the aforementioned need, and more. According to the present invention, there is provided a balanced food product including approximately 40% or less by weight a first fruit component. The balanced food product may also include approximately 30% or less by weight a protein component, as well as approximately 15% or less by weight a sweetener component. Furthermore, the balanced food product may include approximately 10% or less by weight a second fruit component, and approximately 10% or less by weight an oil binding agent component. There may also be approximately 10% or less by weight a water component. The water component is understood to include water separate from the water content of the first fruit component, the protein component, the sweetener component, and the second fruit component. The first fruit component, the protein component, and the second fruit component are in powdered form.

In further detail, the first fruit component may be dried apple, while the second fruit component may be, almonds. The protein component may be soy protein, and the sweetener component may be honey. Further, the oil binding agent component may be canola oil. Each of the aforementioned components contribute a particular amount of carbohydrates; protein; and fat, such that carbohydrates amount to approximately 40% of the total calories, protein amounts to approximately 30% of the total calories, and fat amounts to approximately 30% of the total calories. It is understood that the particular ratio is beneficial for balancing the metabolism of the body, particularly in connection with the carbohydrate component which facilitates the balancing of the levels of insulin and eicosanoids. The particular ingredients utilized further have beneficial effects on the cardiovascular system for improved overall health.

According to the present invention there is also provided a method for producing a balanced food product. The method may include the step of admixing a first fruit component, a protein component, and a second fruit component. The first fruit component, the protein component, and the second fruit component may be of a powder consistency. The admixing step may operative to yield a uniform composition. Next, the method may include the step of adding a water component to the uniform composition. This step may be effective to bind the powder of the uniform composition in a paste consistency. The method may further include the step of adding a sweetener component to the uniform composition. This step may be followed by the step of adding an oil binding agent component to the uniform composition. Thereafter, the uniform composition may be separated into serving units, with each of the serving units having a predetermined weight and being in the paste consistency. The serving units may then be transitioned from the paste consistency to a solid, and packaged.

### DETAILED DESCRIPTION

The detailed description set forth below is intended as a description of the presently preferred embodiment of the invention, and is not intended to represent the only form in which the present invention may be constructed or utilized. The description sets forth the functions and the sequence of steps for developing the invention. It is to be understood, however, that the same or equivalent functions and, sequences may be accomplished by different embodiments that are also intended to be encompassed within the spirit and scope of the invention. It is further understood that the use of relational terms such as first-and second and the like are, used solely to distinguish one from another entity without necessarily requiring or implying any actual such relationship or order between such entities.

The present invention relates to a balanced food product and a method for making the same. The balanced food product effectuates a blood sugar and insulin balance, via a calculated glycemic load, for weight loss and overall improved health. The balanced food product may be consumed between major meals such as breakfast, lunch, and dinner, and form a part of a nutritious and healthy diet.

The novel balanced food product comprises as its essential components a first fruit component, a protein component, a sweetener component, a second fruit component, an oil binding agent component, and water. It is understood that the components may be formed into edible bars, sweets, cookies, biscuits, and the like. Furthermore, one having ordinary skill in the art will appreciate that any desirable weight or size of the balanced food product may be selected, but since in a preferred embodiment the balanced food product is intended for use as a snack the weight is preferably limited to about 56 grams. The form and weight of the balanced food product is presented by way of example only and not of limitation, and any other suitable form and/or weight may be readily substituted without departing from the scope of the present invention.

According to a preferred embodiment, the components of the balanced food product are particular ingredients each having a specific carbohydrate, protein, fat and water content. It is understood that while such specific ingredients are described herein, the present invention is not intended to be limited to such ingredients. Any other ingredient having like or equivalent carbohydrate, protein, fat, and water content values may be utilized in lieu of the preferred ingredients. It will be noted that the term “component” as used herein refers to the general types of ingredients utilized in the balanced food product. Further, the term “ingredient” is understood to refer to the particular ingredient, such as apple, soy, honey, and so forth which are each subsets of the respective components. Thus, any similar ingredient of a particular component may be readily substituted without departing from the scope of the present invention. For the first fruit, a preferred embodiment utilizes an apple, and for the second fruit, almonds. For the preferred legume, the utilization of soy protein is envisioned, and for the preferred sweetener, use of honey is contemplated. Further, canola oil is intended to be used as the preferred oil binding agent. The following table describes the aforementioned components and its constituent ingredient, and the respective percentage by weight of each contained in the balanced food product:

TABLE 1

| | PERCENTAGE |
|---|---|
| INGREDIENT | BY WEIGHT |
| Apples (First Fruit Component) | 35.4% |
| Soy Protein (Legume Component) | 26.5% |
| Honey (Sweetener Component) | 13.3% |
| Almonds (Second Fruit Component) | 8.8% |
| Canola Oil (Oil Binding Agent Component) | 7.1% |
| Water Component | 8.8% |

In the preferred embodiment as described, the total weight of the balanced food product is contemplated to be approximately 56 grams. Given the above percentages by weight of each of the components/ingredients, the following table demonstrates the content of each of the ingredients in grams for a single serving of the balanced food product:

TABLE 2

| INGREDIENT | GRAMS |
|---|---|
| Apple (First Fruit Component) | 20 g |
| Soy Protein (Legume Component) | 15 g |
| Honey (Sweetener Component) | 7.5 g |
| Almonds (Second Fruit Component) | 5.0 g |
| Canola Oil (Oil Binding Agent Component) | 4.0 g |
| Water Component | 5.0 g |
| Total | 56.5 g |

According to a preferred embodiment, the first fruit, or the apple, is understood to be in a dried, form. In such a form, it will be appreciated by one having ordinary skill in the art that approximately 65.9% of the weight of the first fruit is in carbohydrates, while 0.9% of the weight is in protein, 0.3% is in fat, and 31.8% is in water. Given a component weight of 20.0 grams as per the above table, the following table illustrates.the content of the carbohydrates, protein, fat, and water in grams:

TABLE 3

| | CARBO- | | | | |
|---|---|---|---|---|---|
| | HYDRATES | PROTEIN | FAT | WATER | TOTAL |
| Apples (First | 13.2 g | 0.2 g | 0.1 g | 6.4 g | 20.0 g |
| Fruit Component) | | | | | |

It is understood that fruits in general and apples in particular are understood to have a low glycemic index, and so are particularly suited for application in the present inventive balanced food product. As considered in the background, glycemic index values for foods are calculated by comparing measurements of the effect on blood glucose levels. Carbohydrates that break down rapidly and quickly increase the blood glucose level have high glycemic index values, while carbohydrates that break down slowly and gradually increase the blood glucose level have low glycemic index values. One of ordinary skill in the art will readily recognize that digestion of foods having lower glycemic index values are effective to lower insulin demand, and better long-term blood glucose control. There have also been several indications that individuals following a low glycemic index diet were at a significantly lower risk for developing type-2 diabetes and coronary heart disease. In this regard, the use of the low glycemic index value apple ingredient in the balanced food product is provided for improved health benefits to the consumer. Likewise, because the present invention contemplates a known serving size in grams, the balanced food products of the present invention will also have a relatively low glycemic load insofar as the amount of carbohydrate consumed will be proportionately balanced to thus mitigate the consequential blood glucose levels and insulin response that are induced following consumption of the food product.

As described above, the preferred embodiment of the balanced food product includes the protein component, particularly, soy. It will be appreciated that in order to be mixed with the other components, the soy ingredient is in powder form. The particular soy utilized contributes 0% by weight carbohydrates, 97% by weight protein, 0% by weight fat, and 3% by weight water. According to the present invention, it has been determined that the protein component will contribute 15 grams to the total weight of the balanced food product as described in TABLE 2. The following table illustrates the contribution of carbohydrates, protein,. fat, and water in grams for the soy protein component of the balanced food product:

TABLE 4

| | CARBO- | | | | |
|---|---|---|---|---|---|
| | HYDRATES | PROTEIN | FAT | WATER | TOTAL |
| Soy Protein | 0.0 g | 14.6 g | 0.0 g | 0.5 g | 15.0 g |
| (Protein | | | | | |
| Component) | | | | | |

One of ordinary skill in the art will appreciate the use of soy protein in a wide variety of food products, including, but not limited to beverage powders, meat imitations, and so forth. Generally there are three types of soy protein products, namely, isolates, concentrates, and flours. As described in the above graph, the percentage of protein contributed by the protein component is approximately 97%, and isolates are the only type of soy protein products which have such a high protein percentage. It is the most refined form of soy protein, and is made from defatted soy meal which has had most, if not substantially all, of the fats and carbohydrates removed. Conventionally, soy protein isolates are in powdered form.

Soy protein isolates are conventionally utilized to improve the texture of meat products, but is also used for other nutritional, sensorial, and functional purposes. Such functional purposes include applications requiring emulsification, water and fat absorption and adhesion. In this regard, the use of soy protein isolate is particularly useful for forming the balanced food product. Additionally, as evident from the protein contribution described in TABLE 4, the soy protein ingredient serves a nutritional purpose of increasing the protein content in the balanced food product. Further, it is believed that soy protein in particular may contribute to improved cardiovascular health, particularly in lowering serum cholesterol levels, low density lipoprotein cholesterol concentrations, and triglyceride concentrations.

A preferred embodiment of the balanced food product further specifies a 7.5 gram contribution of sweetener to the overall weight of the balanced food product. The sweetener utilized may be honey, any other well known sweetener compound, or, a combination thereof. It will be understood by those having ordinary skill in the art that honey refers to the sweet unadulterated and viscous fluid produced by honeybees and other insects from the nectar of flowers. Depending on the source of the honey, the flavor thereof may vary greatly. Common sources of honey include blackberry, blueberry, and buckwheat, and the flavor of the honey will have the flavor of the dominant source of the region. It is understood that commercially available honey suitable for use in the mass production of food products are typically blended from multiple sources. In a preferred embodiment of the present invention, the sweetener, and particularly the honey ingredient utilized, contributes approximately 82.4% of its total weight in carbohydrates, 0.3% in protein, 0% in fat, and 17.1% in water. Accordingly, the following table illustrates the contribution in grams of the sweetener component separated into carbohydrates, protein, fat, and water:

TABLE 5

| | CARBO- | | | | |
|---|---|---|---|---|---|
| | HYDRATES | PROTEIN | FAT | WATER | TOTAL |
| Honey | 6.2 g | 0.0 g | 0.0 g | 1.3 g | 7.5 g |
| (Sweetener | | | | | |
| Component) | | | | | |

In addition to contributing to the carbohydrate, protein, fat, and water content of the balanced food product, the sweetener is utilized to impart a sweet flavor upon the same. It will also be understood by one of ordinary skill in the art that because honey is hygroscopic, it is suited for use in the balanced food product of the present invention, particularly those embodiments in which the balanced food product is for snack applications. It is understood that honey prevents the balanced food product from becoming stale, and as discussed in the background, a desirable characteristic in snack foods is longevity. Additionally, it has been observed that honey has a low to moderate glycemic index compared to the high glycemicet index of other conventional sweeteners. Such moderate glycemic index, coupled with the moderate amount of grams provided per serving, further helps to reduce the overall glycemic load to the consumer following consumption of the food product, which as discussed above minimizes the potentially adverse effects associated with the consumption of a high glycemic load food product. Accordingly, honey is deemed to be particularly beneficial for the balanced food product in that health-imparting properties are imbued therein.

The present inventive balanced food product further includes a second fruit component. In a preferred embodiment of the present invention, the ingredient of such second fruit component is almonds. As a component of the balanced food product, the almond may be in shredded form, powdered form, or any other form depending on the desired texture characteristics of the balanced food product. It is understood that the preferred almond is approximately 21.2% carbohydrates, approximately 15.1% protein, approximately 59.1% fat, and approximately 1% water. The following table describes the contribution amount in grams of the carbohydrates, protein, fat and water of the second fruit component:

TABLE 6

| | CARBO- | | | | |
|---|---|---|---|---|---|
| | HYDRATES | PROTEIN | FAT | WATER | TOTAL |
| Almonds (Second | 1.1 g | 0.8 g | 3.0 g | 0.1 g | 5.0 g |
| Fruit Component) | | | | | |

According to the knowledge of one having ordinary skill in the art, almonds are the fruit of the almond tree, and share a common genus with plums and cherries. Conventionally, almonds are consumed in conjunction with a variety of foods. A particularly popular use includes sprinkling over desserts such as sundaes and other ice cream dishes, and using the extract as a substitute for vanilla extract. Another popular almond consumption methodology includes snacking thereon, and is the spirit in which the second fruit component has been employed in the present inventive balanced food product. Further, one of ordinary skill in the art will appreciate that almonds are a significant source for monounsaturated fatty acids, which have been understood to reduce cholesterol levels and reduce heart disease risk. Accordingly, the use of almonds as a major contributor to the fat content of the balanced food product is intended to impart significant health benefits, particularly cardiovascular health.

According to the present invention as described in Table 2, the balanced food product includes an oil binding agent component in the amount of 4 grams. It is understood that such component serves as a binder to hold the other components of the balanced food product such as the first fruit, the second fruit, and so forth, as a single discernible unit without disintegration. In addition to the oil binding agent component, 5 grams of water are added to adhere each of the components together.

In a preferred embodiment, the oil binding agent component is 100% fat, and so contributes 4 grams in fat. Specifically, the ingredient of the oil binding agent component is canola oil, or Canadian rapeseed oil, chosen for its health benefits. As will be appreciated, canola oil is comprised of approximately 7% of saturated fat, 61% of monounsaturated fat, and 32% polyunsaturated fat. As discussed above, monounsaturated fat and polyunsaturated fat have cardiovascular benefits of reducing cholesterol.

Having considered each of the components of the balanced food product, the total weight of the carbohydrates, protein, fat, and water from Tables 3, 4, 5 and 6 is described in the following table:

TABLE 7

| | CARBO- | | | | |
|---|---|---|---|---|---|
| | HYDRATES | PROTEIN | FAT | WATER | TOTAL |
| All Components | 20.4 g | 15.5 g | 7.0 g | 13.1 | 56.1 g |

As explained above, the desirable total weight for the balanced food product is approximately 56 grams, and the present balanced food product meets this requirement. Further, considering that carbohydrates have approximately 4 calories per gram, that protein has approximately 4 calories per gram, and fat has approximately 9 calories per gram, the following table illustrates the respective calorie contribution of the carbohydrates, the protein, and the fat, as well as its percentage with respect to the total calorie number.

TABLE 8

| | CARBOHYDRATES | PROTEIN | FAT | Total |
|---|---|---|---|---|
| Calorie | 84 Calories | 64 | 63 | 211 Calories |
| Contribution | | Calories | Calories | |
| Calorie | 40% | 30% | 30% | 100% |
| Percentage | | | | |

Per the description of Table 8, the balanced food product contains 40% of the total caloric content in carbohydrates, 30% of the total caloric content in protein, and 30% of the total caloric content in fat, which as explained in the background, is the effective ratio to properly balance insulin and eicosanoid levels, particularly when the carbohydrate has the aforementioned low to moderate glycemic index and provided in limited quantities to thus provide a reduced glycemic load when consumed. Along these lines, it will further be appreciated that by the selection of low glycemic index value components, the stress applied to the body by blood sugar level spikes is reduced, resulting in improved health. Additionally, the selection of monounsaturated and polyunsaturated fats are effective to help reduce the overall caloric content of the food product. The balanced food product may further be fortified with additional vitamins, minerals, nutraceuticals, and/or other compositions that are operative to impart a desired therapeutic benefit in addition to those described above.

With respect to the production of the balanced food product, according to a preferred embodiment of the present invention, initially the first fruit component, the second fruit component, and the protein component are admixed. It is understood that the ingredient utilized in the first fruit component, as explained above, is dried apple, the second fruit component is almonds, and the protein component is soy protein. In this particular embodiment, the first fruit component, the second fruit component, and the protein component are of a powder consistency. It will be appreciated by those having ordinary skill in the art that the powder consistency enables these three components to be readily mixed into a uniform composition. Next, water is added to the uniform composition, binding the individual particles of powder to each other and resulting in a paste or semi-solid composition. Thereafter, the sweetener component is admixed into the uniform composition, followed by the oil binding agent component. The uniform composition is then separated and solidified into individual serving units.

It will be appreciated that any number of well known techniques may be utilized to form and package the individual serving units, including extruding the individual serving units and inserting the same into a packaging. Solidifying the uniform composition may involve baking of the same, or alternatively, frozen. In accordance with a preferred embodiment of the present invention, no-stick packaging may be utilized as taught by U.S. patent application Ser. No. 10/742,157 by Ehlman, et al., which is wholly incorporated by reference herein. As understood, Ehlman; et al. teaches a food product including a release agent associated with the outer surface of a food item such that it substantially prevents the packaging within which the food product is contained from adhering to the food item as the packaging is removed from the food item. Furthermore, Ehrman, et al. teaches a wrapper having first and second opposing segments that together forms a peelable seal around the food item. It will be appreciated that the present inventive balanced food product may be packaged in similar fashion. One of ordinary skill in the art will recognize, however, that any suitable packaging may be utilized without departing from the scope of the present invention.

It is understood that the particular powder form of the first fruit component, the second fruit component, and the protein component is provided by way of example only and not of limitation. For example, slices of dried apple may be utilized as part of the uniform composition, as well as other forms of soy protein, including the aforementioned concentrate and flour forms. Further, crushed almonds may be utilized instead of powdered almonds. A person of ordinary skill in the art will recognize that numerous forms of the various components are possible, depending on the desired texture and taste characteristics of the balanced food product.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to explain details of the present invention in greater depth than is necessary for the fundamental understanding of the present invention, the description making apparent to those skilled in the art how the several forms of the present invention may be embodied in practice.

What is claimed is:

1. A balanced food product, comprising:
approximately 40% or less by weight a first fruit component;
approximately 30% or less by weight a protein component;
approximately 15% or less by weight a sweetener component;
approximately 10% or less by weight a second fruit component;
approximately 10% or less by weight an oil binding agent component; and
approximately 10% or less by weight a water component, the water component including water separate from the water content of the first fruit component, the protein component, the sweetener component, and the second fruit component;
wherein the first fruit component, the protein component, the sweetener component, the second fruit component, the oil binding agent component, and the water component are uniformly mixed.

2. The balanced food product of claim 1, wherein the first fruit component, the protein component, and the second fruit component are in powdered form.

3. The balanced food product of claim 1, wherein the first fruit component contributes approximately 66% by weight in carbohydrates, approximately 1% by weight in protein, and approximately 32% by weight in water.

4. The balanced food product of claim 3, wherein the first fruit component is dried apple.

5. The balanced food product of claim 1, wherein the second fruit component contributes approximately 21% by weight in carbohydrates, approximately 15% by weight in protein, approximately 59% by weight in fat, and approximately 1% by weight in water.

6. The balanced food product of claim 5, wherein the second fruit component is almond.

7. The balanced food product of claim 1, wherein the protein component contributes approximately 97% by weight in protein, and approximately 3% by weight in water.

8. The balanced food product of claim 7, wherein the protein component is soy protein.

9. The balanced food product of claim 1, wherein the sweetener component contributes approximately 82% by weight in carbohydrates, and approximately 18% by weight in water.

10. The balanced food product of claim 9, wherein the sweetener component is honey.

11. The balanced food product of claim 10, wherein the oil binding agent component contributes approximately 100% by weight in fat.

12. The balanced food product of claim 11, wherein the oil binding agent component is canola oil.

13. The balanced food product of claim 1, wherein the first fruit component is present in the amount of 35.4% by weight.

14. The balanced food product of claim 1, wherein the protein component is present in the amount of 26.5% by weight.

15. The balanced food product of claim 1, wherein the sweetener component is present in the amount of 13.3% by weight.

16. The balanced food product of claim 1, wherein the second fruit component is present in the amount of 8.8% by weight.

17. The balanced food product of claim 1, wherein the oil binding agent component is present in the amount of 7.1% by weight.

18. The balanced food product of claim 1, wherein the water component is present in the amount of 8.8% by weight.

19. A method for producing a balanced food product, the method comprising the steps of:
admixing a first fruit component, a protein component, and a second fruit component, the first fruit component, the protein component, and the second fruit component being of a powder consistency, the admixing step being operative to yield a uniform composition having a powder consistency;
adding a water component to the uniform composition, the step of adding water being effective to bind the powder of the uniform composition in a paste consistency;
adding a sweetener component to the uniform composition;
adding an oil binding agent component to the uniform composition;
separating the uniform composition into serving units, each of the serving units having a predetermined weight and being in the paste consistency; and
transitioning the serving units from the paste consistency to a solid;
wherein the first fruit component is approximately 40% or less by weight of the uniform composition, the protein component is approximately 30% or less by weight of the uniform composition, the sweetener component is approximately 15% or less by weight of the uniform composition, the second fruit component is approximately 10% or less by weight of the uniform composition, the sweetener component is approximately 10% or less by weight of the uniform composition, the oil binding agent component is approximately 10% or less by weight of the uniform composition, and the water component is approximately 10% or less by weight of the uniform composition.

20. The method of claim 19, wherein the first fruit component is dried apple.

21. The method of claim 19, wherein the second fruit component is almonds.

22. The method of claim 19, wherein the protein component is soy protein.

23. The method of claim 19, wherein the sweetener component is honey.

24. The method of claim 19, wherein the oil binding agent component is canola oil.
